(19) United States
(12) Patent Application Publication
(10) Pub. No.: US 2025/0346096 A1
(43) Pub. Date: Nov. 13, 2025

(54) DEVICE FOR A FRAMELESS VEHICLE DOOR

(71) Applicant: Brose Fahrzeugteile SE & Co. Kommanditgesellschaft, Bamberg, Bamberg (DE)

(72) Inventors: Stefan KAISER, Altendorf (DE); David KRAUSE, Ebelsbach (DE); Andreas LIEB, Kemmern (DE); Christoph LURZ, Breitengüssbach (DE); Eike RITTHALER, Litzendorf (DE); Bernd STROBEL, Niederfüllbach (DE); Frank WAGNER, Nürnberg (DE)

(21) Appl. No.: 18/879,914

(22) PCT Filed: Jun. 14, 2023
(86) PCT No.: PCT/EP2023/065996

§ 371 Date: Feb. 19, 2025

(30) Foreign Application Priority Data
Jun. 30, 2022 (DE) 10 2022 206 717.7

(51) Int. Cl. B60J 1/17; B25B 23/00; E05D 13/00; E05D 15/16

(52) U.S. Cl. CPC B60J 1/17; B25B 23/0064; E05D 13/10; E05D 15/165; E05Y 2201/628; E05Y 2600/12; E05Y 2600/322; E05Y 2600/56; E05Y 2600/62; E05Y 2600/624; E05Y 2900/55

(57) ABSTRACT

A device for a frameless vehicle door includes a counter bearing, a guide rail mounted thereon for a window regulator, and an adjusting device for inclining the guide rail along an adjusting direction oriented obliquely to the counter bearing. The adjusting device can be actuated by a tool. An access direction of the tool is oriented obliquely to the adjusting direction. The adjusting device has at least two adjusting components that can be moved relative to one another, namely, a threaded bolt oriented along the adjusting direction and at least one threaded nut screwed thereon. One of the adjusting components is fixed to the guide rail or the counter bearing for conjoint rotation, and the other is rotatably mounted. The rotatably mounted adjusting component has a drive contour and can be driven by to axially adjust the adjusting components with respect to one another along the adjusting direction.

The invention relates to a device for a frameless vehicle door, said device comprising a counter bearing having a guide rail mounted thereon for a window regulator and having an adjusting device located therebetween for inclining the guide rail along an adjusting direction oriented perpendicularly to the counter bearing. The invention further relates to a door module and a frameless vehicle door having such a device.

A “frameless vehicle door” is understood to mean here and hereinafter, in particular, a vehicle door without a window frame for the (window) pane, in which the pane is lowered in a door seal on the body side. Such frameless vehicle doors are used, for example, in convertible vehicles.

The functional components of a vehicle door, for example the window regulator, drive device, side airbag module, loudspeaker, control unit or the like, are generally pre-mounted on an assembly support of a door module, also called the door module support or support plate. The door module or the assembly support is installed in a door cutout of a door frame or a door shell of the vehicle door.

Window regulators for vehicle doors are designed, for example, with a cable pull mechanism for lifting and for lowering a (window) pane. In such a window regulator, the pane is guided by means of a driver element or rail slider along at least one guide rail. The cable pull mechanism typically has a cable pull which is guided, on the one hand, in one of these winding and unwinding cable drums and, on the other hand, by single or multiple deflection on the driver element or rail slider and fixed therein.

When used in a frameless vehicle door, it can arise that due to production tolerances the pane protrudes, for example, from the door seal, forming a gap, or the pane is pressed so forcibly against the door seal that sluggishness and increased wear occur due to the increased friction.

In order to compensate for these assembly or production tolerances, therefore, it is frequently necessary to tilt or to incline the pane in the mounted state on the vehicle door along an adjusting direction perpendicular to the assembly support (in the vehicle transverse direction Y), in order to pretension the window pane in this direction relative to the door seal in a desired manner.

For such tolerance compensation, for example, it is possible to use a double-threaded bolt with axial accessibility as the adjusting element. The double-threaded bolt, for example, can be screwed, on the one hand, into the guide rail and, on the other hand, into the assembly support so that, when the double-threaded bolt is rotated, the components are moved toward one another or away from one another, whereby the inclination of the guide rail relative to the door module or the assembly support is adjustable.

Typically an (adjusting) tool, for example a screwdriver, is provided for rotating the double-threaded bolt, wherein in this context an “axial accessibility” is understood to mean that the tool is guided in the axial direction, i.e. the longitudinal direction, of the double-threaded bolt relative thereto, and engages in a tool receiver of the double-threaded bolt on the front face. The adjusting direction and the access direction of the tool are thus oriented parallel to one another in this case. This means that the access direction of the tool is generally oriented perpendicularly to the assembly support, i.e. in the vehicle transverse direction Y. Since the tolerance compensation takes place in an installed state in the vehicle door, for example, it is thus necessary to remove the door inner panel for the tolerance compensation, whereby the effort for the assembly of the vehicle door is disadvantageously increased. An additional drawback is the use of a special tool (combination tool, also called a hold-and-drive screwdriver) for releasing, holding and rotating the double-threaded bolt with the nut.

An access direction which is oriented at right-angles or perpendicularly to the adjusting direction (vehicle transverse direction Y) for the tool is generally possible only by means of a large gear mechanism so that an integrated solution on a door module is disadvantageously made more difficult.

The object of the invention is to specify a particularly suitable device for a frameless vehicle door. In particular, a tolerance compensation which is structurally simple and compact in terms of installation space is to be specified for adjusting a rail inclination of a window pane in a vehicle door. The object of the invention is also to specify a particularly suitable door module and a particularly suitable frameless vehicle door.

Regarding the device, the object is achieved according to the invention by the features of claim 1 and regarding the door module by the features of claim 13 and regarding the vehicle door by the features of claim 14. Advantageous embodiments and developments form the subject matter of the dependent claims. The advantages and embodiments set forth regarding the device are also expediently transferrable to the door module and/or the vehicle door and vice versa.

The conjunction “and/or” is understood to mean here and hereinafter that the features linked by means of this conjunction can be configured both together and as alternatives to one another.

The device according to the invention is provided for a frameless vehicle door and is suitable and designed therefor. The device has a fixed or stationary counter bearing on which a guide rail for a window regulator is premounted. For example, the guide rail is a part of a cable window regulator for the vehicle door. The counter bearing, for example, is an assembly support (support plate) of a door module which is mounted or can be mounted in the vehicle door or a door shell of the vehicle door.

The device also has an adjusting device. The adjusting device is provided and designed to tilt and to pivot or to bend or to incline the guide rail along an adjusting direction which is oriented obliquely to the counter bearing. In other words, a spacing or a clear width between the guide rail and the counter bearing can be adjusted at least in some portions by the adjusting device.

“Obliquely” is to be understood to mean here and hereinafter, in particular, a substantially perpendicular orientation, i.e. for example 90°±45°, in particular 90°±30°, preferably 90°±15°, particularly preferably 90°±5°.

A tolerance compensation of production and/or assembly tolerances regarding the pane inclination can be implemented by the adjusting device, so that a guided by the window regulator along the adjusting direction can be pretensioned in a desired manner relative to a door seal of the vehicle door. According to the invention, for the tolerance compensation it is not the window pane which is tilted or pivoted but the guide pane on which the window pane is guided by means of a driver element or rail slider. The pane inclination of a window pane guided by the window regulator is thus indirectly adjusted or set by an inclination of the guide rail relative to the counter bearing. As a result, a uniform shaft passage of the window pane through a door sill shaft of the vehicle door can be implemented when the guide rail is adjusted.

The adjusting device is arranged between the guide rail and the counter bearing. In other words, the adjusting device is arranged below the guide rail, wherein this positioning results in an arrangement of the components which is particularly compact in terms of installation space. Expediently, the adjusting device is arranged in an upper and/or lower region of the guide rail, i.e. in the vicinity of a cable pulley of the guide rail.

The adjusting device can be actuated by a tool, wherein an access direction of the tool for actuating the adjusting device is oblique to the adjusting direction. For example, the access direction is oriented substantially perpendicularly to the adjusting direction.

Information regarding the spatial directions is also specified hereinafter, in particular in a coordinate system of the motor vehicle (vehicle coordinate system) relative to an exemplary installed situation of the door module in a frameless side door of the motor vehicle. The abscissa axis (X-axis, X-direction) is oriented in the vehicle longitudinal direction (direction of travel) and the ordinate axis (Y-axis, Y-direction) is oriented in the vehicle transverse direction and the applicate axis (Z-axis, Z-direction) is oriented along the vehicle height.

The counter bearing, i.e. for example the assembly support or door shell, is arranged substantially in the X-Z plane, wherein the rail longitudinal direction of the guide rail is arranged substantially along the vehicle height Z. The adjusting direction is oriented obliquely to the X-Z plane, i.e. for example substantially in the vehicle transverse direction Y, wherein the access direction extends substantially within or parallel to the X-Z plane.

The adjusting device has at least two adjusting components that can be moved relative to one another and are in the form of a threaded bolt oriented along the adjusting direction (threaded shaft) and at least one threaded nut. The threaded bolt has an external thread and the threaded nut has a corresponding internal thread, wherein the threaded bolt and the threaded nut are in threaded engagement. In other words, the at least one threaded nut is screwed or rotated onto the threaded bolt. An adjusting device which is structurally particularly simple and cost-effective is implemented by the use of standard components (threaded bolt, threaded nut).

“Axial” or an “axial direction” is understood to mean here and hereinafter, in particular, a direction parallel (coaxial) to the longitudinal direction of the threaded bolt, i.e. perpendicular to the front faces of the threaded nut. The axial direction and the adjusting direction are thus arranged substantially parallel in the vehicle transverse direction Y. Accordingly, “radial” or a “radial direction” is understood to mean here and hereinafter, in particular, a direction oriented perpendicularly (transversely) to the threaded bolt along a radius of the threaded nut.

One of the adjusting components, i.e. either the threaded bolt or the at least one threaded nut, is fixed to the guide rail or the counter bearing for conjoint rotation therewith. In other words, this adjusting component is joined to the guide rail/the counter bearing for conjoint rotation therewith. The respective other adjusting component is rotatably or rotationally mounted. The rotatably mounted adjusting component has a drive contour by means of which the adjusting component can be driven, i.e. can be rotated, directly or indirectly by the tool, such that a relative axial adjustment of the adjusting components to one another takes place along the adjusting direction, and thus the adjusting device is actuated. At least with a tool engagement, an angular gear, in particular a 90° deflection gear, for example a bevel gear, is formed by the tool and the adjusting device. This adjusting component is moved relative to the fixed adjusting component due to the threaded engagement by driving or rotating the rotatable adjusting component. As a result, a reliable and structurally simple adjustment of the adjusting device, i.e. a tolerance compensation, is made possible for the orientation and inclination of the window pane which can be integrated in the door shell or in a door module. A particularly suitable device is thus implemented.

A device which is particularly efficient in terms of installation space is implemented by the compact construction of the adjusting device and the arrangement thereof which is compact in terms of installation space below the guide rail. The adjusting device can be positioned relatively freely along the guide rail, whereby additional freedom in terms of the design and mounting of the counter bearing is possible.

An adjustment of the rail inclination—and thus the pane inclination—with a right-angled access to the drive is implemented by the adjusting device. The access or the access direction can be arranged in a variable rotational manner about the thread axis (adjusting direction, axial direction) of the threaded bolt, so that a particularly flexible and variable embodiment is made possible. In other words, the access direction in the X-Z plane is arranged substantially radially to the adjusting direction or to the threaded bolt. The access direction can thus be oriented in a rotational manner to the thread axis depending on the use or customer requirements. In one conceivable embodiment, the access direction is oriented substantially perpendicularly to a longitudinal direction of the guide rail (i.e. substantially perpendicularly to the vehicle vertical direction Z). The adjusting device is thus provided and designed, for example, to be actuated in the X-direction with a tool. The tool access is implemented, in particular, from a front face of the vehicle door on the door lock side.

The access direction is thus oriented, for example, substantially in the X-direction. The expression “substantially in the direction” is to be understood here and hereinafter, in particular, “in the direction”±45°, preferably ±30°, particularly preferably ±5°.

In an advantageous development, the threaded nut is the rotatably mounted adjusting component which can be driven by the tool. The drive contour is integrally formed on an axial front face of the threaded nut. The threaded bolt is mounted on or in the guide rail for conjoint rotation therewith and axially protrudes, for example, from a lower face of the guide rail facing the counter bearing. A particularly compact construction results from positioning the bolt “below” the guide rail with an interface to the counter bearing. The drive contour is designed, for example, as a toothing, for example as a bevel gear toothing.

Preferably, the threaded nut is received in a fixed interface. In an expedient embodiment, the threaded nut is arranged radially positively in a bead-like receiver and held axially positively. The receiver can be part of the counter bearing, in particular an assembly support or door shell.

A “positive-fit connection” or a “positive connection” between at least two parts connected to one another is understood to mean here and hereinafter, in particular, that the cohesion of the parts connected to one another at least in one direction is implemented by a direct interlocking of contours of the parts themselves or by an indirect interlocking via an additional connecting part. The “blocking” of a mutual movement takes place in this direction, i.e. as a function of the shape.

The fixedly mounted threaded bolt is thus installed in the guide rail and mounted in the drivable threaded nut which is positively received in the receiver. By rotating or driving the threaded nut, the threaded bolt moves and entrains the guide rail so that the position or inclination thereof along the adjusting direction (axial direction, vehicle transverse direction Y) changes.

The receiver has, for example, an axial through-opening or recess (blind hole) through which or in which the threaded bolt can be guided in some portions. A greater adjustment travel for the adjusting device and thus a greater play for tolerance compensation is implemented by the axial engagement of the threaded bolt enabled thereby.

In one conceivable embodiment, a bearing shell, also denoted as a retaining bracket, is provided for the axial positive holding of the threaded nut. The bearing shell, in particular, is releasably fastened to the counter bearing and/or the guide rail, for example is fastened by screws and at least partially encompasses the receiver. Alternatively, for example, it is also conceivable that the receiver is part of the bearing shell. The bearing shell thus axially surrounds the threaded nut with the counter bearing. Preferably, the bearing shell also has a tool guide for the tool which is oriented in the access direction and which leads into the receiver. The tool guide is formed, for example, as a groove or bead in the bearing shell. An access to the drive contour is ensured by the tool guide, therefore, even when a bearing shell is mounted.

In an alternative development, the adjusting device is designed in the manner of a turnbuckle. In this development, the threaded bolt is the rotatably mounted adjusting component. Preferably, two threaded nuts are provided as fixed adjusting components, wherein one of the threaded nuts is fixed to the guide rail and the other threaded nut is fixed to the assembly support.

In an expedient embodiment, the threaded bolt is designed as a double-threaded rod with two external threads at the opposing rod ends. Preferably, the external threads are designed in opposing directions to one another. In other words, one of the external threads is designed as a right-hand thread and the other external thread is designed as a left-hand thread. In each case, one of the threaded nuts is screwed onto the right-hand thread and onto the left-hand thread. The drive contour in the form of a drive toothing is arranged between the external threads, i.e. approximately centrally or at half the axial height of the threaded bolt. The radial drive toothing is designed with straight teeth in the axial direction. By driving the threaded bolt with the central drive toothing, the guide rail and the assembly support are moved away from one another or toward one another.

In an advantageous embodiment, the drive contour or drive toothing is in meshing engagement with a screw element which is rotatable by the tool. The screw element is oriented in the access direction, i.e. perpendicularly to the threaded bolt. The rotatably mounted screw element forms a worm gear with the drive contour. This means that the threaded bolt is driven or drivable only indirectly by the tool. A particularly fine adjustment or tolerance compensation in the tensioning screw-adjusting device is made possible by the screw element.

In a further alternative development, the threaded bolt is rotatably mounted on a holder, wherein the threaded nut which is fixed in terms of rotation is connected to the guide rail and is axially displaced when the thread of the threaded bolt is rotated.

The holder is substantially C-shaped or U-shaped, in particular with right-angled bends, and has a vertical holding limb (vertical limb) and on the opposing limb ends two horizontal holding limbs (horizontal limbs) oriented perpendicularly thereto. The vertical limb is oriented parallel to the adjusting direction, wherein the horizontal limbs are oriented parallel to the plane of the counter bearing. The limbs substantially form an arcuate holding clamp for the threaded bolt which is arranged in a chord-like manner and which is rotatably mounted in the horizontal limbs of the holder. The threaded bolt is axially positively held in the holder.

In an expedient embodiment, the holder is arranged spaced-apart from the counter bearing via two holding limbs. The holding limbs or holding tabs are preferably integrally formed on the holder, i.e. in one piece or monolithically, in particular on the lower horizontal limbs (facing the assembly support). The holding limbs are designed, for example, to be L-shaped, wherein the horizontal L-shaped limb forms the support or interface for the assembly support. For example, the horizontal L-shaped limb is designed as a screw tab or screw flange for screw-fastening the holder to the counter bearing.

A clear spacing or intermediate space is formed between the counter bearing and the lower horizontal limb by the spaced-apart arrangement. The threaded bolt extends at least in some portions into the intermediate space formed thereby. In other words, the threaded bolt penetrates the lower horizontal limb at least in some portions. The drive contour of the threaded bolt is provided on this front face which is arranged in the intermediate space. For example, the threaded bolt has a bolt head with an integrally formed drive contour, for example in the form of a bevel gear toothing. The drive contour is thus positioned between the holding limbs. Thus at least one of the holding limbs has a through-opening which is oriented in the access direction at the height of the drive contour. As a result, a simple and reliable access of the tool is ensured.

The door module according to the invention has an assembly support as a support plate or door module support and a device as described above. The assembly support preferably forms the counter bearing for the device. The guide rail of the device, for example, is also a part of a cable window regulator which is premounted on the assembly support. This produces a particularly suitable door module in which the means for adjusting a pane inclination on the assembly support are integrated.

The frameless vehicle door according to the invention is, for example, a side door of a motor vehicle, in particular a convertible vehicle. The vehicle door has, for example, an above-described door module. A window regulator with a window pane is arranged on the door module. Alternatively, it is possible that the device is mounted without a door module or without an assembly support in the vehicle door, for example. In this case, a door shell of the vehicle door forms the counter bearing of the device. This means that the device is directly fastened to the door shell.

A simple adjustment for tolerance compensation of the pane inclination is made possible by the adjustability of the guide rail or the inclination thereof relative to the assembly support. As a result, a particularly suitable frameless vehicle door is implemented.

Exemplary embodiments of the invention are explained in more detail hereinafter by way of a drawing, in which:

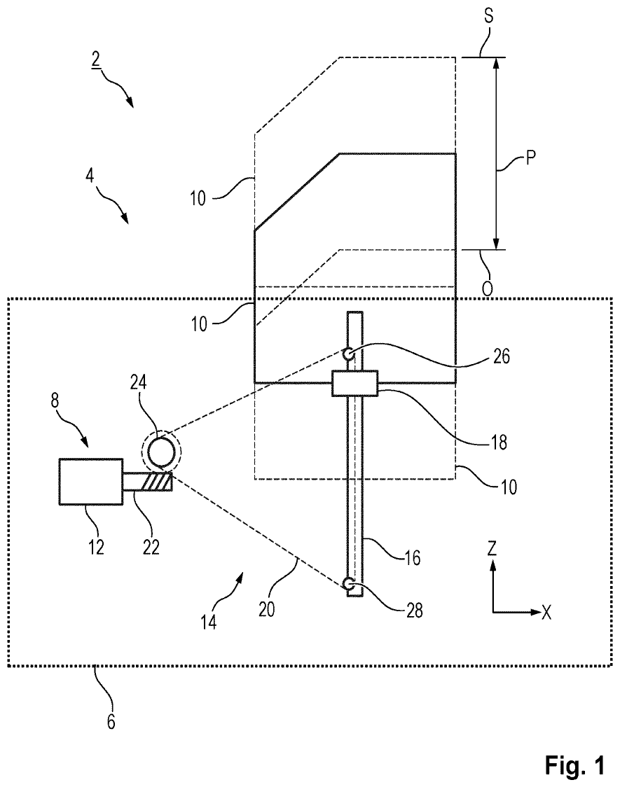

FIG. 1 shows a frameless vehicle door with a door module in a schematic view,

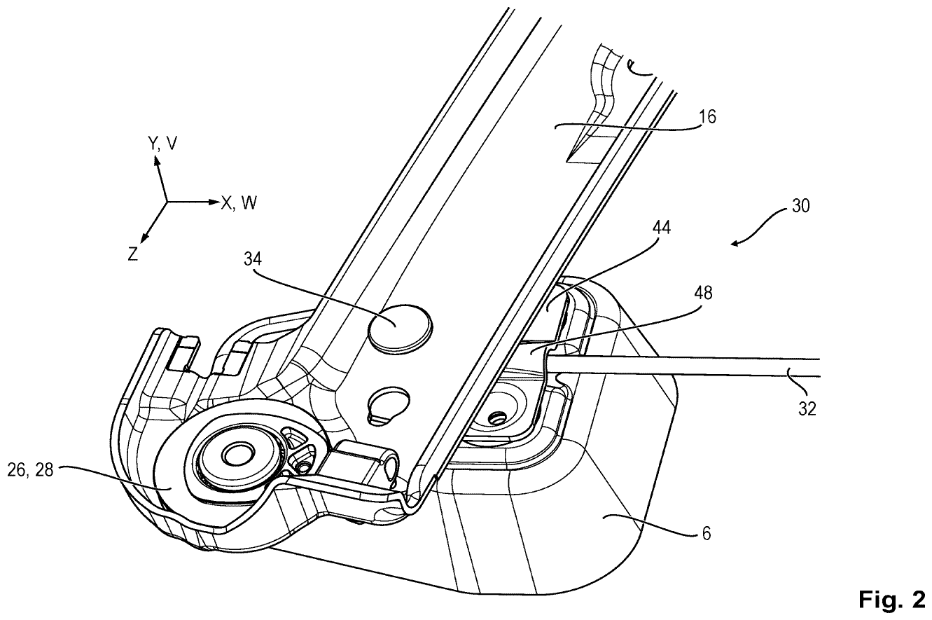

FIG. 2 shows a detail of an adjusting device of the door module for adjusting a guide rail in a perspective view,

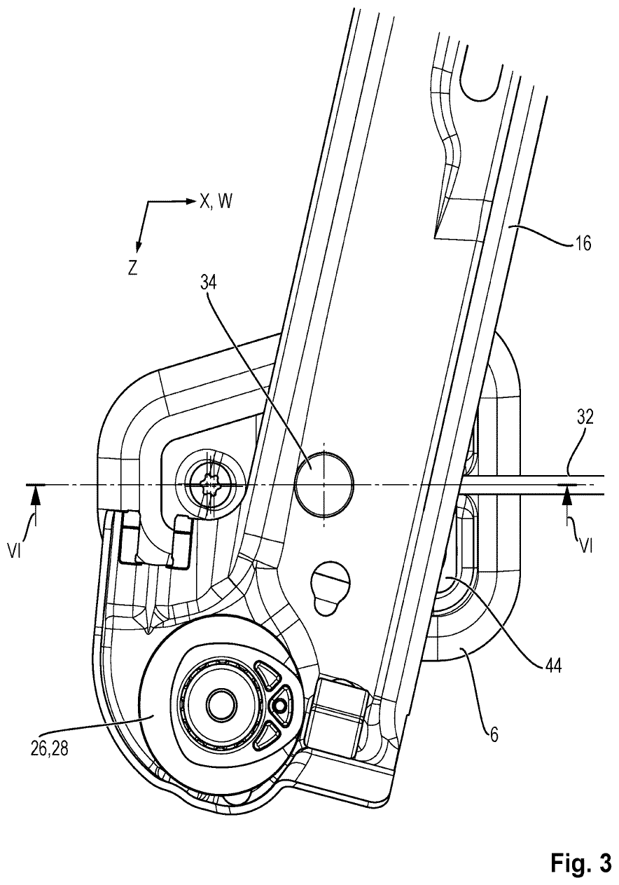

FIG. 3 shows the adjusting device in a plan view,

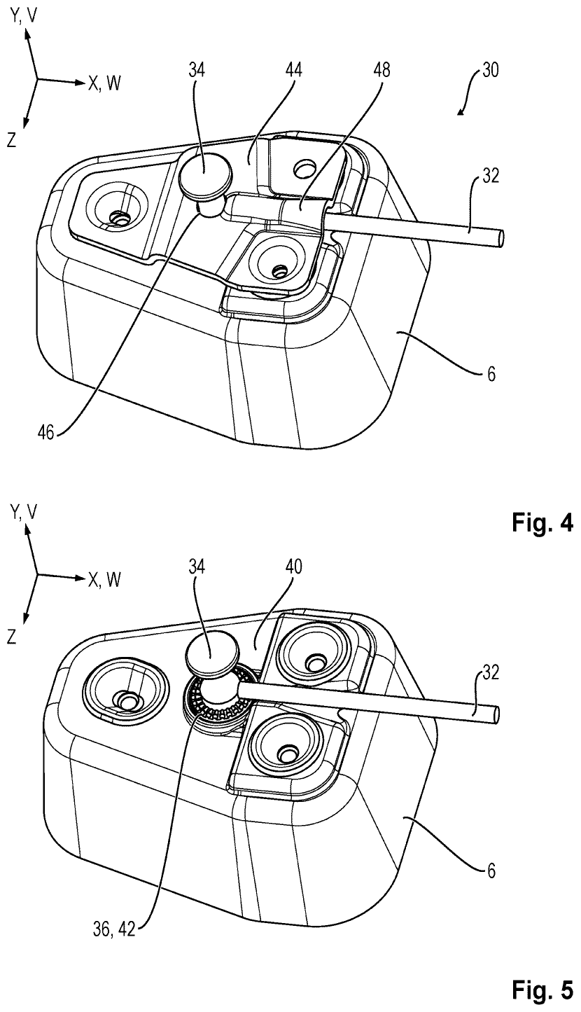

FIG. 4 shows the adjusting device in a perspective view,

FIG. 5 shows the adjusting device with the retaining bracket removed in a perspective view,

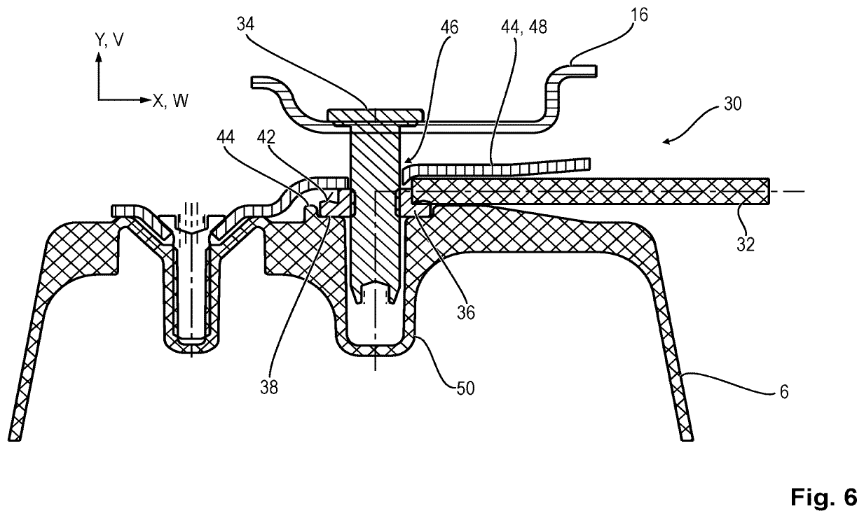

FIG. 6 shows the adjusting device along the cutting line VI-VI according to FIG. 3 in a sectional view,

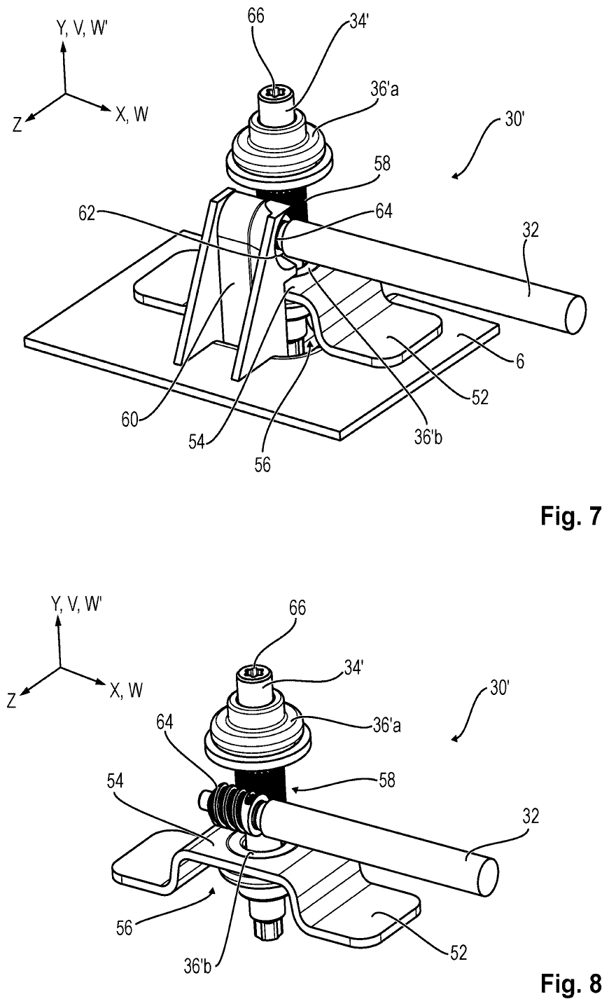

FIG. 7 shows the adjusting device in a second embodiment in a perspective view,

FIG. 8 shows the adjusting device according to the second embodiment without a retaining contour in a perspective view,

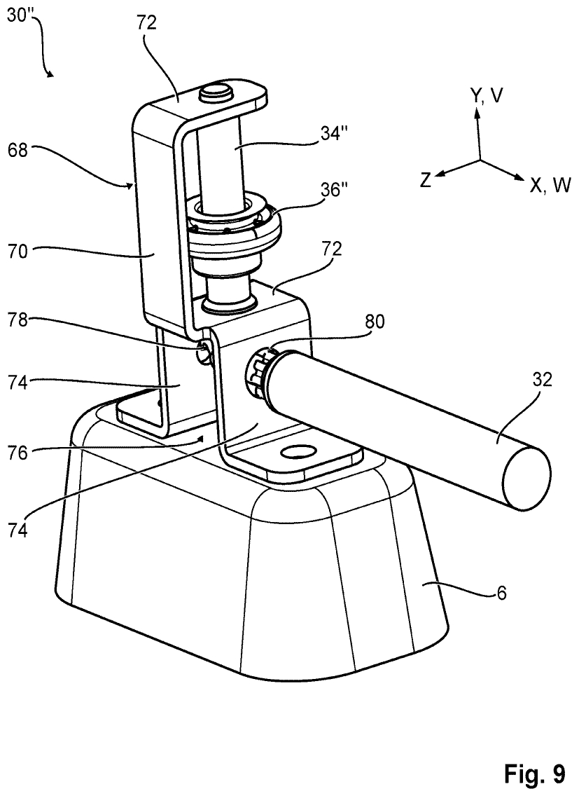

FIG. 9 shows the adjusting device according to a third embodiment in a perspective view,

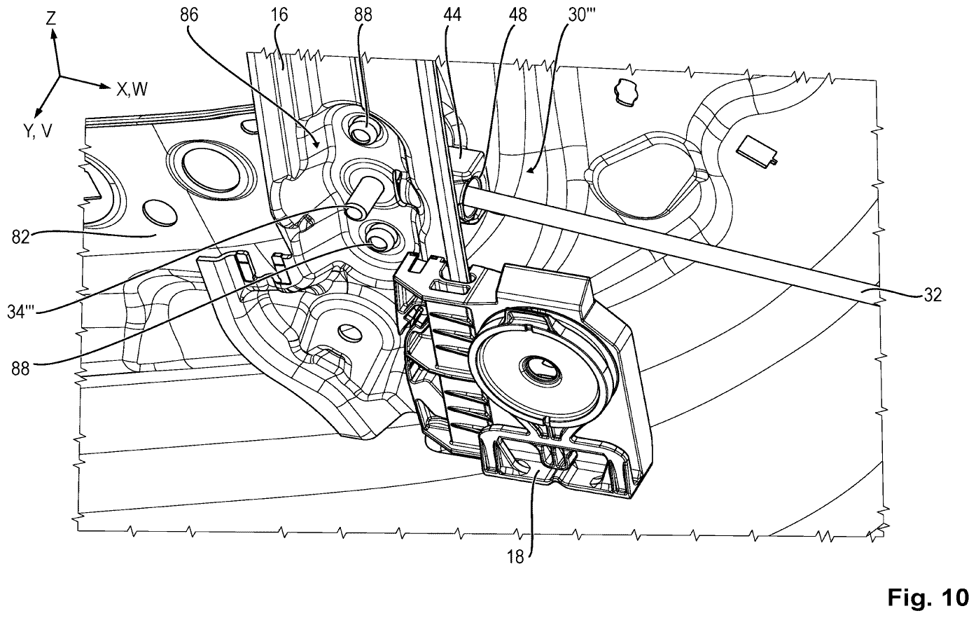

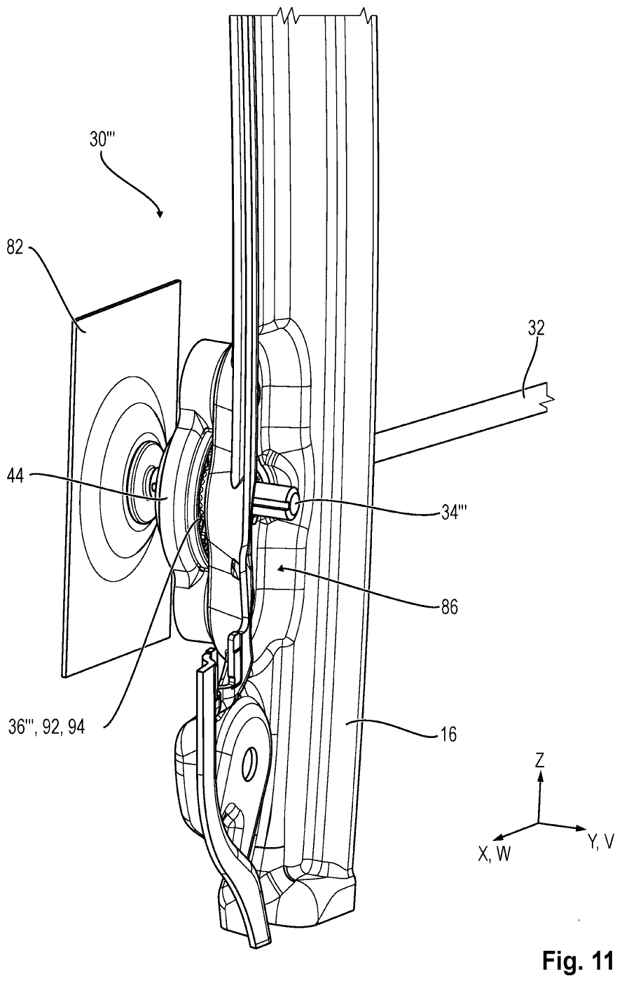

FIG. 10 shows the adjusting device according to a fourth embodiment in a perspective view,

FIG. 11 shows the adjusting device according to the fourth embodiment in a perspective view, and

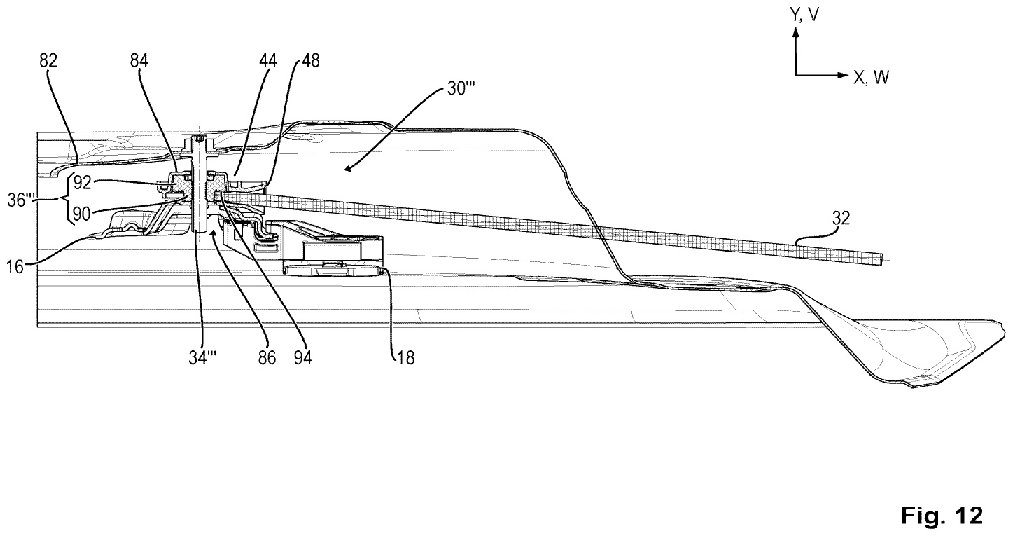

FIG. 12 shows the adjusting device according to the fourth embodiment in a sectional view.

Parts and sizes which correspond to one another are always provided with the same reference signs in all of the figures.

A frameless vehicle door 2 with an optional door module 4 is shown in a simplified and schematic view in FIG. 1. The door module 4 has an assembly support 6 with an electric window regulator 8 mounted thereon as an adjusting device for a (vehicle) window pane 10. Alternatively, the window regulator 8 can also be installed without a door module 4 or assembly support 6.

The window regulator 8 has an actuating motor 12 which acts on the window pane 10 by means of an actuating mechanism 14. The actuating mechanism 14 has a guide rail 16 and a driver element or rail slider 18 coupled to the window pane 10.

In the exemplary embodiment shown, the window regulator 8 is designed as a simply guided cable window regulator. The actuating mechanism 14 has a cable pull 20 in addition to the guide rail 16.

The actuating motor 12 of the window regulator 8 drives a cable drum 24 of the actuating mechanism 14 via a worm gear or spur gear 22. A pull cable of the cable pull 20 is arranged on the cable drum 24 such that the pull cable is wound up and unwound during rotations of the cable drum 24 brought about by the gear mechanism 22.

An upper cable pulley or cable roller 26 and a lower cable roller 28, which are arranged on the opposing (rail) front faces or rail ends, are fastened to the guide rail 16. The pull cable of the cable pull 20 is guided around the cable rollers 26, 28.

When the actuating motor 12 is actuated, the window pane 10 is moved into its (pane-) position P. The window pane 10 is movable in a reversible manner between a closed position S which represents the highest possible position P and an open position O which represents the lowest possible position P. In these positions S and O, the window pane 10 is indicated in each case in dashed lines in FIG. 1. The window pane 4, however, is shown by solid lines in a half-open intermediate position.

Information regarding spatial directions is also specified hereinafter, in particular in a coordinate system of the motor vehicle (vehicle coordinate system) relative to a vehicle door 2 designed as a side door. The abscissa axis (X-axis, X-direction) is oriented in the vehicle longitudinal direction (direction of travel) and the ordinate axis (Y-axis, Y-direction) is oriented in the vehicle transverse direction and the applicate axis (Z-axis, Z-direction) is oriented along the vehicle height.

The assembly support 6 is arranged substantially in the X-Z plane, wherein the rail longitudinal direction of the guide rail 16 is arranged substantially along the vehicle height Z.

The door module 4 also has a device, not denoted further, with an adjusting device 30. The adjusting device 30 is provided and designed to tilt or to pivot or to bend or to incline the guide rail 16 along an adjusting direction V oriented perpendicularly to a counter bearing. The adjusting direction V is oriented substantially in or parallel to the Y-direction.

A first exemplary embodiment of the device 30 is explained in more detail hereinafter by way of FIGS. 2 to 6. In this exemplary embodiment, the counter bearing is formed by the assembly support 6 and is also denoted as such hereinafter.

As visible in particular in FIG. 2 and in FIG. 3, in this embodiment the adjusting device 30 is arranged between the guide rail 16 and the assembly support 6. The adjusting device 30 is arranged in an upper and/or lower region of the guide rail 16, i.e. in the region of the cable roller 26 and/or 28.

The adjusting device 30 can be actuated by a tool 32. During the course of an adjustment or a tolerance compensation in a (tool) access direction W, the tool 32 is brought into an operative connection with the adjusting device 30. The access direction W for the tool 32 for actuating the adjusting device 30 is arranged obliquely or perpendicularly to the adjusting direction V. In the exemplary embodiment shown, the access direction W is oriented, in particular, substantially in the vehicle longitudinal direction X.

As is visible in FIGS. 4 to 6, for example, in this embodiment the adjusting device 30 of the device has two relatively movable adjusting components 34, 36 in the form of a threaded bolt 34 oriented along the adjusting direction V and a threaded nut 36 screwed thereon.

The threaded nut 36 is rotatably received in a bead-like receiver 38 of the assembly support 6. The receiver 38 is surrounded by an edge 40 which protrudes axially and which is integrally formed on the assembly support 6 and which radially positively holds the threaded nut 36. The threaded nut 36 has a drive contour 42 in the form of a bevel gear toothing on the upper front face facing the guide rail 16. The tool 32 has a corresponding tool contour which can be brought into meshing engagement with the drive contour 42, wherein a 90° deflection gear is effectively implemented via the contours. This means that in this embodiment the adjusting device 30 can be driven directly or in a direct manner by means of the tool 32.

In order to secure the threaded nut 36 against axially sliding out of the receiver 38, a bearing shell 44, also denoted as a retaining bracket, is provided, the retaining bracket being fastened by screws to the assembly support 6 such that it at least partially encompasses the receiver 38 so that the threaded nut 36 is held axially positively between the bearing shell 44 and the base of the receiver 38 or the assembly support 6. The retaining bracket 44 is not shown in FIG. 5.

In this exemplary embodiment, the bearing shell 44 encompasses the threaded nut 36, in particularly fully. In other words, the threaded nut 36 is covered on the front face by the bearing shell 44. The bearing shell 44 has a through-opening 46 for the threaded bolt 34 which is arranged so as to be aligned or coaxial with the receiver 38. Moreover the bearing shell 44 has a tool guide 48 for the tool 32 which is oriented in the access direction W and which leads into the receiver 38. The tool guide 48 is shaped as a groove or bead in the bearing shell 44.

In the center, a blind hole-like recess 50 is integrally formed in the receiver 38, the threaded bolt 34 engaging at least in some portions in said receiver. The axial depth of the recess 50 is dimensioned so as to be substantially equal to the axial length of the threaded bolt 34 and thus effectively corresponds to the adjustment travel of the adjusting device 30. In particular, the base of the recess 50 forms a mechanical (end) stop for the front face of the threaded bolt 34 during the course of an adjustment or actuation of the adjusting device 30.

The threaded bolt 34 is mounted on or in the guide rail 16 for conjoint rotation therewith and protrudes axially in the direction of the recess 50 from a lower face of the guide rail 16 which faces the assembly support 6. The fixedly mounted threaded bolt 34 is thus installed in the guide rail 16 and mounted in the drivable threaded nut 36 which is radially and axially positively received on the assembly support 6. By rotating or driving the threaded nut 36 by means of the tool 32, the threaded bolt 34 moves via the interlocking threads along the adjusting direction V and entrains the guide rail 16 so that the position or inclination thereof changes along the adjusting direction V.

A second exemplary embodiment for the device is shown in FIG. 7 and in FIG. 8 and explained in more detail hereinafter. The counter bearing of the device is formed by the assembly support 6.

The adjusting device 30′ of the device in this embodiment is designed in the manner of a turnbuckle. The adjusting device 30′ has two threaded nuts 36a, 36b and a threaded bolt 34′ designed as a double-threaded rod. The threaded nut 36a is coupled to the guide rail 16 for conjoint rotation therewith, wherein the threaded nut 36b is fastened to a holder 52 for conjoint rotation therewith. The holder 52 is joined to the assembly support 6, for example, by a screw connection.

The holder 52 has a central portion 54 which is raised in a step-like manner and in which the threaded nut 36b is arranged. The central portion 54 of the holder 52 is thus arranged axially spaced-apart from the assembly support 6 so that an intermediate space 56 is formed between the central portion 54 and the assembly support 6. The central portion 54 has a through-opening for the threaded bolt 34′ so that during the course of an adjustment travel of the adjusting device 30′ this threaded bolt can be moved into the intermediate space 56.

The rotatably mounted threaded bolt 34′ is designed in each case with an external thread at the opposing rod ends. The external threads are designed in opposing directions to one another as a left-hand thread and as a right-hand thread. The drive contour 58 is arranged in the form of a drive toothing between the external threads, i.e. approximately centrally or at half the axial height of the threaded bolt 34′. The radial drive contour 58 is designed with straight teeth in the axial direction.

A retaining bracket 60 with a receiver 62 which is approximately C-shaped in cross section for a screw element 64 designed as a grub screw is integrally formed, i.e. in one piece or monolithically, on the assembly support 6 adjacent to the threaded bolt 34′. The retaining bracket 60 or the receiver 62 are arranged such that the external thread the screw element 64 rotatably mounted therein is in meshing engagement with the drive contour 58. The screw element 64 forms a worm gear with the drive contour 58.

The screw element 64 is oriented in the access direction W, i.e. perpendicularly to the threaded bolt 34′, and has a tool receiver on the front face, for example a hexagon socket or hexalobular socket (Torx) for a corresponding tool contour of the tool 32.

Optionally a further tool receiver 66 is provided on the front face of the threaded bolt 34′ on the guide rail side. The tool receiver 66 is designed, for example, as a hexalobular socket (Torx). The adjusting device 30′ or the threaded bolt 34′ can be actuated by the tool receiver 66 in an access direction W′ oriented parallel to the adjusting direction V. As a result, the adjusting device 30′, for example with an inner panel of the vehicle door 2 removed, can also be actuated or driven in the Y-direction.

By driving the threaded bolt 34′, the guide rail 16 and the assembly support 6 are moved away from one another or toward one another due to the opposing external threads. The adjusting device 30′ can be driven directly or in a direct manner by the tool 32 and the tool receiver 66 from the Y-direction. The adjusting device 30′ is also provided and designed to be driven indirectly by the tool 32 engaging in the screw element 64 from the X-direction.

FIG. 9 shows a third embodiment of the device in which the counter holder is formed by the assembly support 6. In this embodiment, the threaded bolt 34″ of the adjusting device 30″ is rotatably mounted on a holder 68, wherein a threaded nut 36″ is connected to the guide rail 16 for conjoint rotation therewith and is axially adjusted along the threaded bolt 34″ when the thread is rotated.

The holder 68 is substantially C-shaped or U-shaped and has a vertical holding limb (vertical limb) 70, two horizontal holding limbs (horizontal limbs) 72 oriented perpendicularly thereto being integrally formed on the opposing limb ends thereof. The vertical limb 70 is oriented parallel to the adjusting direction V, wherein the horizontal limbs 72 are oriented parallel to the plane of the assembly support 6 (XZ). The limbs 70, 72 substantially form an arcuate retaining bracket for the threaded bolt 34″ which is arranged in a chord-like manner relative thereto and which is rotatably mounted and axially positively held in the horizontal limbs 72.

The holder 68 is arranged spaced-apart from the assembly support 6 via two holding limbs 74. The holding limbs 74 are preferably integrally formed, i.e. in one piece or monolithically, on the lower horizontal limbs 72. The holding limbs are designed to be L-shaped, for example, in the X-Y plane, wherein the horizontal L-shaped limb forms the support or interface with the assembly support 6. For example, the horizontal L-shaped limb is designed here as a screw tab or screw flange for screw-fastening the holder 68 to the assembly support 6.

The intermediate space 76 is formed between the assembly support 6 and the lower horizontal limb 72 due to the spaced-apart arrangement by means of the holding limbs 74. The threaded bolt 34″ extends at least in some portions into the intermediate space 76. In other words, the threaded bolt 34″ penetrates at least in some portions through the lower horizontal limb 72. The threaded bolt 34″ has a drive contour 78 in the form of a bevel gear toothing on the front face which is arranged in the intermediate space 76. The holding limbs 74 have in each case a through-opening 80 which is oriented in the access direction W and which is level with the drive contour 78.

A fourth exemplary embodiment of the device is explained in more detail hereinafter with reference to FIGS. 10 to 12. In this embodiment, the adjusting device 30″ is installed in the vehicle door 2 without an assembly support 6 or door module 4. In particular, the adjusting device 30′″ is fastened to a door shell 82. In this exemplary embodiment, the door shell 82 forms the counter bearing and is also denoted as such hereinafter.

The adjusting device 30′″ has a fixed threaded bolt 34′″ along the adjusting direction V which is secured to the door shell 82 on the head side. The threaded bolt 34′″ protrudes from the door shell 82 substantially in the Y-direction. The threaded nut 36′″ is rotatably mounted in a pot-shaped receiver 84 of the bearing shell 44.

The bearing shell 44 or the receiver 84 has a central through-opening which is penetrated by the threaded shaft of the threaded bolt 34′″. Moreover, the bearing shell 44 has tool guide 48 for the tool 32 which is oriented in the access direction W and which leads into the receiver 84. The tool guide 48 is designed here as an approximately frustoconical channel of the bearing shell 44.

The guide rail 16 has a bead-like holding contour 86 which is oriented in the direction of the door shell 82. The bearing shell 44 is fixed by means of two fastening screws 88 to the holding contour 86, whereby the threaded nut 36′″ is axially positively held between the receiver 84 and the holding contour 86. The guide rail 16 is thus indirectly secured via the adjusting device 30′″ to the door shell 82. The guide rail 16 has a through-opening, not denoted further, which is penetrated by the free end of the threaded bolt 34′″.

The threaded nut 36′″ has a shaft portion 90 extending along the threaded bolt 36′″ and a head portion 92 located radially positively in the receiver 84. A drive contour 92 for the tool 32, for example in the form of a bevel gear toothing, is incorporated on the head portion 92 on the front face which faces the guide rail 16.

By rotating or driving the threaded nut 36′″ by engaging the tool 32 in the drive contour 92, the threaded nut 36′″ is moved along the threaded bolt 34′″ via the interlocking threads along the adjusting direction V and, due to the attachment of the bearing shell 44, entrains the guide rail 16 so that the position or inclination thereof changes along the adjusting direction V.

The claimed invention is not limited to the exemplary embodiments described above. Rather, other variants of the invention can be derived by a person skilled in the art within the scope of the disclosed claims, without departing from the subject matter of the claimed invention. In particular all of the individual features described in connection with the different exemplary embodiments are also able to be combined in different ways within the scope of the disclosed claims without departing from the subject matter of the claimed invention.

List of Reference Signs

| | |
|---|---|
| 2 | Vehicle door |
| 4 | Door module |
| 6 | Assembly support, counter bearing |
| 8 | Window regulator |
| 10 | Window pane |
| 12 | Actuator |
| 14 | Actuating mechanism |
| 16 | Guide rail |
| 18 | Driver element |
| 20 | Cable pull |
| 22 | Worm gear/spur gear |
| 24 | Cable drum |
| 26, 28 | Cable roller |
| 30, 30′, 30″, 30′″ | Adjusting device |
| 32 | Tool |
| 34, 34′, 34″, 34′″ | Threaded bolt |
| 36, 36a′, 36b′, 36″, 36′″ | Threaded nut |
| 38 | Receiver |
| 40 | Edge |
| 42 | Drive contour |
| 44 | Retaining bracket, bearing shell |
| 46 | Through-opening |
| 48 | Tool guide |
| 50 | Recess |
| 52 | Holder |
| 54 | Central portion |
| 56 | Intermediate space |
| 58 | Drive contour |
| 60 | Holding contour |
| 62 | Receiver |
| 64 | Screw element |
| 66 | Tool receiver |
| 68 | Holder |
| 70 | Holding limb/vertical limb |
| 72 | Holding limb/horizontal limb |
| 74 | Holding limb |
| 76 | Intermediate space |
| 78 | Drive contour |
| 80 | Through-opening |
| 82 | Door shell, counter bearing |
| 84 | Receiver |
| 86 | Holding contour |
| 88 | Fastening screw |
| 90 | Shaft portion |
| 92 | Head portion |
| 94 | Drive contour |
| P | Pane position |
| O | Open position |
| S | Closed position |
| X | Vehicle longitudinal direction |
| Y | Vehicle transverse direction |
| Z | Vehicle vertical direction |
| V | Adjusting direction |
| W, W′ | Access direction |

1-14. (canceled)

15. A device for a frameless vehicle door, the device comprising:
a counter bearing having a guide rail mounted thereon for a window regulator and having an adjusting device disposed therebetween for inclining said guide rail along an adjusting direction that is oriented obliquely to said counter bearing;
said adjusting device being configured for actuation by a tool;
an access direction of the tool for actuating said adjusting device being oriented obliquely to the adjusting direction;
said adjusting device having at least two adjusting components that are movable relative to one another, said at least two adjusting components being a threaded bolt oriented along the adjusting direction and at least one threaded nut meshing with said threaded bolt;
one of said adjusting components being fixed to said guide rail or said counter bearing for conjoint rotation therewith, and a respectively other said adjusting component being rotatably mounted; and
said rotatably mounted adjusting component having a drive contour and being drivable by way of said tool to axially adjust said adjusting components relative to one another along the adjusting direction.

16. The device according to claim 15, wherein the access direction (W) is oriented obliquely to a longitudinal direction of said guide rail.

17. The device according to claim 15, wherein said threaded nut is said rotatably mounted adjusting component, and wherein the drive contour is integrally formed on a front face of said threaded nut.

18. The device according to claim 17, wherein said threaded nut is disposed in a bead-shaped receiver holding said threaded nut in an axially positive form lock in said receiver.

19. The device according to claim 17, which comprises:
a bearing shell fastened to at least one of said counter bearing or said guide rail; and
said bearing shell having a tool guide for the tool that is oriented in the access direction.

20. The device according to claim 19, wherein said receiver forms a part of said counter bearing and said bearing shell at least partially encases said receiver.

21. The device according to claim 15, wherein said threaded bolt is said rotatably mounted adjusting component.

22. The device according to claim 21, wherein:
said threaded bolt is a double-threaded rod with two external threads and having a drive toothing forming the drive contour arranged therebetween; and
a respective said threaded nut is screwed onto each of said external threads, said threaded nut being coupled, on one hand, to said guide rail and, on another hand, to said counter bearing for conjoint rotation therewith.

23. The device according to claim 22, which further comprises a screw element which is rotatable by the tool and which is in meshing engagement with the drive contour.

24. The device according to claim 21, which further comprises a C-shaped holder arranged on said counter bearing and axially positively surrounding said threaded bolt.

25. The device according to claim 24, wherein:
said C-shaped holder is arranged spaced-apart from said counter bearing via two holding limbs;
said threaded bolt extends at least in some portions into an intermediate space formed thereby, wherein the drive contour is arranged on a front face in the region of said intermediate space; and
at least one of said holding limbs is formed with a through-opening for the tool which is oriented in the access direction.

26. The device according to claim 15, wherein said counter bearing is an assembly support of a door module or a door shell of the vehicle door.

27. A door module for a frameless vehicle door, comprising an assembly support and a device according to claim 15, wherein said assembly support is the counter bearing of said device.

28. A frameless vehicle door for a motor vehicle, comprising a device according to claim 15.
